(19) United States
(12) Patent Application Publication
(10) Pub. No.: US 2017/0278313 A1
(43) Pub. Date: Sep. 28, 2017

(54) ONBOARD VEHICLE DIAGNOSTIC, MONITORING, SAFETY, AND MAINTENANCE SYSTEM

(71) Applicants: Nermin Maslar, Peoria, AZ (US); Awais Agha, Glendale, AZ (US); John Bentley, Santa Clara, CA (US); Bob King, Peoria, AZ (US); Norman D Dean, Surprise, AZ (US)

(72) Inventors: Nermin Maslar, Peoria, AZ (US); Awais Agha, Glendale, AZ (US); John Bentley, Santa Clara, CA (US); Bob King, Peoria, AZ (US); Norman D Dean, Surprise, AZ (US)

(21) Appl. No.: 15/077,586

(22) Filed: Mar. 22, 2016

(51) Int. Cl. G07C 5/00; G07C 5/08

(52) U.S. Cl. CPC G07C 5/008; G07C 5/006; G07C 5/0841

(57) ABSTRACT

A device, method, and system may remotely monitor one or more subsystems in a terrestrial vehicle. In one embodiment, a method and system may schedule maintenance and order replacement parts after comparing the reported data with threshold data. In one embodiment, stake-holders, law enforcement entities, government agencies, and national security organizations may access the reported data. In one embodiment, a modular device may monitor vehicle subsystems, vehicle environmental data, a driver's heart beat, a driver's eye activity, a driver's head position, vehicle environmental data, and a driver's ID data.

### FIELD OF TECHNOLOGY

This disclosure relates generally to the technical field of devices, systems, and methods that remotely monitor terrestrial vehicles (e.g. trucks).

### BACKGROUND

Millions of heavy-duty trucks operate in US and deliver nearly 70% of all U.S. freight, amounting to billion dollars worth of manufactured and retail goods per year. Operating and maintaining a truck or a fleet of trucks is costly, and may be measured not only in fuel, parts and labor, but also in downtime. Truck accidents or breakdowns are also costly. Therefore, it is an object of this invention to reduce accidents and breakdowns by improving safety, spotting risky driver behaviors (e.g. drowsiness and intoxication), and lowering fuel costs; It is further an object of this invention to lower the cost of vehicle maintenance by reducing downtime, negotiating for parts and labor, and improving the effectiveness of maintenance.

In addition, stakeholders in a vehicle, law enforcement, regulatory agencies, revenue agencies, and national security organizations lack automated aids to monitoring truck traffic. Managing trucks and assessing the operating costs and operating risks of truck traffic is largely a manual process involving physical inspections and personal interviews. Therefore, it is an object of this invention to automate remote truck monitoring, in part by transmitting vehicle operating data to an accessible database.

A vehicle monitoring system must support a variety of communication protocols in order to transmit data from a vehicle subsystem to a stationary transceiver. Thus, it is also an object of the invention to use modular components where possible to support component and supplier flexibility.

### SUMMARY

In one embodiment a device, method, and system may monitor the subsystems of a terrestrial vehicle (e.g. truck). In one embodiment a device may collect data from the vehicle and may use a wireless radio unit to communicate the collected data to a stationary transceiver. The collected data may comprise operating data that may be accepted from the on-board diagnostic (OBD) system of the vehicle, which is the vehicle's self-diagnostic and reporting system. The wireless radio unit and the stationary transceiver may be part of a cellular radio network. The device may also collect and communicate environment data, driver data, and driver status data, including but not limited to an ID of the driver, a head position of the driver, eye activity of the driver, and a heart beat of the driver. The device may act on the collected data to, for example, improve vehicle safety and avoid accidents. The collected data may be accepted from the stationary transceiver by a processor and then stored in a database. From the database the collected data may be compared to threshold data to determine when to schedule maintenance procedures and order parts, and driving distance (i.e. driving time) may be computed to select on-route service locations and estimate arrival times.

Other embodiments will be apparent from the following description and the appended claims.

### BRIEF DESCRIPTION OF THE DRAWINGS

Example embodiments are illustrated by way of example and not limitation in the figures of accompanying drawings, in which like references indicate similar elements and in which:

FIG. 1 is a block diagram illustrating the in-vehicle device according to one or more embodiments.

FIG. 2 is a block diagram illustrating the remote database according to one or more embodiments.

FIG. 3 is a block diagram illustrating the monitoring method according to one or more embodiments, wherein the method steps may be in any order.

FIG. 4 is a block diagram illustrating the monitoring method, continued from FIG. 3, according to one or more embodiments, wherein the method steps may be in any order.

FIG. 5 is a block diagram illustrating the monitoring method, continued from FIG. 4, according to one or more embodiments, wherein the method steps may be in any order.

Other features of the present embodiments will be apparent from the accompanying Drawings and from the Detailed Description that follows.

### DETAILED DESCRIPTION

In one embodiment a device, method, and system may monitor the subsystems of a terrestrial vehicle (e.g. truck). A device may collect data from the vehicle 100 and may use a wireless radio unit 107 to communicate the collected data to a stationary transceiver 111. The collected data may comprise operating data 207 that may be accepted from the on-board diagnostic (OBD) system 100 of the vehicle and may comprise a timestamp of collected data. An OBD system 100 is a vehicle's self-diagnostic and reporting system that provides access to the status of the various vehicle subsystems.

Vehicle OBD systems 100 support a variety of protocols that have been developed by the automotive industry. A protocol converter 102 comprising a first processing unit may accept operating data 207 from a subsystem 100 of the vehicle using one or more of these protocols 101 and convert the signals into a second (e.g. more general purpose) protocol 103 such as RS232 or USB. The protocol converter 102 may, in turn, communicate the converted data to a second processing unit 104 using the second protocol 103. Alternatively, the protocol converter 102 may be eliminated and the second processing unit 104 may accept the operating data 207 from the vehicle OBD system 100 without the intermediate conversion.

The second processing unit 104 may also interact with and accept data from one or more location sensors 105, one or more status sensors 105, one or more driver sensors 105, and one or more environment sensors 105. In addition, the second processing unit 104 may be communicatively coupled with a monitor 105, a printer 105, a CD/DVD unit 105, speakers 105, microphones 105, or another computer peripheral 105. Any data accepted from these other units 105, any data accepted from the vehicle OBD system 100, and any device status comprise the collected data that may be managed, stored, and communicated by the second processing unit 104.

The second processing unit 104 may store the collected data to a data storage unit 109 having a fourth processing unit and third transceiver, wherein the storing uses a third protocol 108 (e.g. a data storage protocol such as SPI, SD bus, CF) or uses the second protocol 103 (e.g. USB).

The second processing unit 104 may also forward the collected data to at least one wireless radio unit 107 having a third processing unit and second transceiver. That at least one wireless radio unit 107 and the stationary transceiver 111 may be part of a cellular radio network (e.g. GSM, HSPA+, CDMA, EVDO, WiMax, LTE), a satellite radio network (e.g. non-terrestrial microwave network), or another electromagnetic network (e.g. Wifi, IEEE 802.11, Bluetooth). The second processing unit 104 may be communicatively coupled with the at least one wireless radio unit 107 via another wireless radio network. Thus the fourth protocol 106 may be a wireless protocol (e.g. Wifi, Bluetooth) or a wired protocol.

The device may collect and communicate driver ID data 201 from the driver sensor 105. The driver ID data 201 may comprise a unique identity of the driver and other supporting driver information (e.g. address, phone number, driver's license info, emergency contact info, blood type, allergies, other health information, insurance info, safety record, photo, physical description, payroll identity). A driver ID sensor may collect driver ID data 201 using a camera (e.g. facial recognition), biometric reader (e.g. finger print recognition), ID card/fob reader (e.g. bar code, magnetic card reader, smart card, Wiegand card, proximity card), unique vehicle ignition key, unique keypad code, or phone ID (e.g. retrieved via NFC, Wifi, or Bluetooth). The supporting information may be collected by the driver ID sensor or may be previously entered and then associated with the unique driver ID following its collection by the driver ID sensor. The device may take action based on the driver ID data 201, including commanding the vehicle OBD to slow, stop, lock, or disable the vehicle when the driver is unknown.

The device may collect and communicate driver status data 202 from the status sensor 105. The driver status data 202 may comprise a heart beat of the driver (e.g. from video using ballistocardiographic micro-movements of the driver's head, from video using photoplethysmographic micro-changes in the driver's face, from ballistocardiographic transducers on the driver's seat, from conventional skin contact EKG, from EKG leads mounted on driver's seat and/or steering wheel), driver body language extracted from video of the driver (e.g. subdued, restless, angry, sleepy, alert), driver eye activity extracted from video of the driver (e.g. blink interval, blink duration, blink frequency, % of time lid is closed, lid closure speed, lid drooping, eye saccade parameters, eye fixation duration), driver head and mouth position (e.g. extracted from video of the driver head drooping, head nodding, yawning), micro-adjustments of steering wheel (e.g. reduced number of micro-adjustments indicates drowsiness, measured from video of driver, measured from wheel angle sensor), driver respiration (e.g. respiratory photoplethysmography, respirometer), blood pressure (e.g. cuff, pulse arrival time), or activity level of the driver (e.g. accelerometer on the driver's seat). The status sensor 105 may comprise one or more cameras, infra-red illuminators, transducers on the driver's seat, transducers on the steering wheel, respirometers, blood pressure cuffs, accelerometers, or similar sensors. The status sensor 105 may comprise one or more microphones, one or more speakers, or an interface to a vehicle integrated communication system for prompting, alerting, and communicating with the driver. The driver status data 202 may be used to monitor the performance of drivers, spot sleepy drivers, identify inattentive or combative drivers, spot risky health issues, spot risky behaviors, recognize when the driver is absent from the vehicle, and spot drivers under the influence of drugs/alcohol. The device may take action based on the driver status data 202, including alerting the driver (e.g. speaker), alerting a fleet manager, alerting another stake-holder, alerting law enforcement, alerting emergency responders, ranking or rating the driver, storing the data for future use, and commanding the vehicle OBD (e.g. to slow, stop, or lock the vehicle).

The device may also collect and communicate location data 204 of the vehicle from the location sensor 105. The location data 204 may comprise a longitude and latitude of the vehicle, a unique location in another map coordinate system, a street address, and a direction of travel. The location sensor 105 may comprise a GPS/GNSS satellite receiver, a compass, an altimeter, radiolocation (e.g. via cellular basestations or other signals), electromagnetic communication (e.g. beacons/receivers near roads and on vehicles). Action may be taken based on the location data 204, including advising the driver of an upcoming turn; advising the driver of traffic, road closures, an Amber alert, or a road hazards; scheduling maintenance and fuel at a location near the vehicle's location or destination; sorting destinations based on traffic, road closures, weather, travel times, or road hazards; and setting destinations based on the vehicle location.

The device may also collect and communicate vehicle environment data 205 from an environment sensor 105. The vehicle environment data 205 is information from the environment of the vehicle and may comprise video of the space around the vehicle (e.g. dashcam, roofcam, bumper-cam, trailer-cam, side-camera, back-camera, forward-camera), radar imaging of the space around the vehicle, lidar imaging of the space around the vehicle, other imaging of the space around the vehicle (e.g. ultrasonic), and moisture sensors (e.g. humistor). An environment sensor 105 may collect environment data 205 using a camera (e.g. photodetector, optics), transducer (e.g. radio antenna, piezoelectric, actuator, microphone, photoelectric, thermoelectric), electronic sensor, or speed sensor. Action may be taken based on the environment data 205, including alerting the driver, alerting a fleet manager, alerting another stake-holder, alerting law enforcement, alerting emergency responders, storing the data for future use, and commanding the vehicle OBD (e.g. to slow or stop the vehicle).

Once the collected data is communicated to the stationary transceiver 111 it may be accepted from the stationary transceiver 111 by an off-vehicle (i.e. remote) processor and stored (e.g. in a database). From the database the collected data may be compared to threshold data to determine when to schedule maintenance procedures and order parts (e.g. replacement parts). A message may be send to order a part or schedule maintenance when the collected data or a function of the collected data is compared with (e.g. traverses) a threshold. Threshold data may be derived in part from historic collected data that was collected at an earlier time using the same method. For example, brake maintenance may be scheduled using on an algorithm that considers miles driven, elevation traversed, driver ID, traffic encountered, and other collected data. In another example, tire maintenance, replacement, or rotation may be scheduled using an algorithm that considers distance driven, turns made, speed profile, the specs of the tires, and other collected data. In these examples, the thresholds for maintenance may be established in part using historic data, statistical analysis, and e.g. machine learning. Driving distance (i.e. driving time) may be computed to select service locations, part locations, fuel locations, and arrival times estimated.

Technicians may be given access to the collected data to diagnose or investigate service issues. Pricing may be accepted from technicians. Technicians may be selected after considering their pricing, travel times to the location of the service and/or part, and travel times to a destination of the vehicle following the service. For example, prior to tire replacement, tread repair, or tire rotation service, bids may be requested from technicians that are on-route and off-route to a destination of the vehicle, and a bid selected that minimizes the total cost of the service, including parts, labor, taxes, downtime, and travel time. A driving time may be computed between the vehicle location and another location (e.g. destination, service, fuel, food, room) and messages sent to negotiate rates, request pricing, advise personnel of estimated arrival times, provide payment, and reroute the vehicle or another asset.

Access to the collected data may be given to a law enforcement entity, a government agency, revenue agency, and a national security organization in order to assist enforcement activity, avoid a cost, and comply with requests. Access to the collected data may also be given to an owner of the vehicle, a manager of the vehicle, a supplier of vehicle maintenance, a supplier of vehicle parts, an operator of the vehicle, another stakeholder, another vendor, and another interested party. For example, a law enforcement entity may access the weight data for a truck to ensure compliance with weight limits, or phone the truck driver by entering the truck license plate.

The remote processor (i.e. remote server) may communicate a command to the stationary transceiver 111, the wireless radio unit 107 may accept the command from the stationary transceiver 111; the command may be communicated from the wireless radio unit 107 to the second processing unit 104; the command may be communicated from the second processing unit 104 to the protocol converter 102; and the command may be communicated from the protocol converter 102 to the subsystem of the vehicle. The command may, for example, direct the OBD system 100 to slow, stop, turn off, or lock the vehicle. The second processing unit 104 may, based on its own processing, communicate with the driver (e.g. via speaker and microphone) or communicate a command to a subsystem of the vehicle (e.g. via the protocol converter 102) to e.g. slow, stop, turn off, or lock the vehicle.

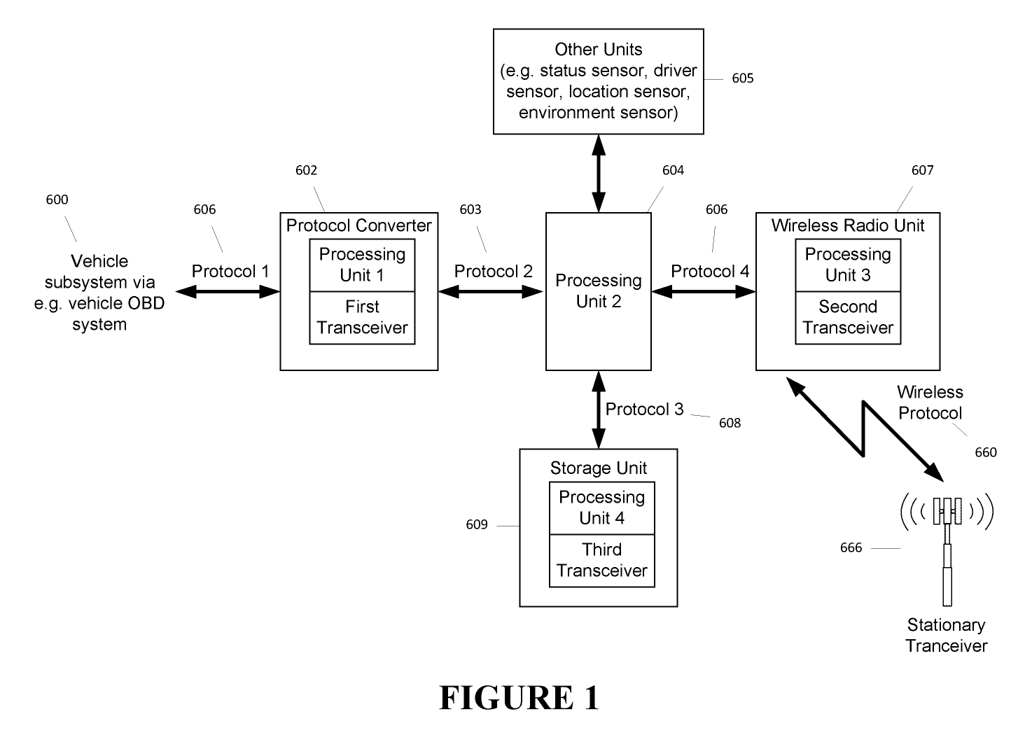

In the embodiment of FIG. 1, the device may comprise a protocol converter 102 which may comprise a first processing unit and a first transceiver (e.g. transmitter and receiver); a second processing unit 104; a wireless radio unit 107 which may comprise a third processor and a second transceiver (e.g. transmitter and receiver); a storage unit 109 which may comprise a fourth processor and a third transceiver (e.g. transmitter and receiver); and other units 105. The other units 105 may comprise one or more status sensors 105, driver sensors 105, location sensors 105, and environment sensors 105. The device may be configured to communicate with an OBD system 100 of the vehicle and a stationary transceiver 111 that is communicatively coupled with a database server configured to host the collected data. The protocol converter 102 may communicate in a first protocol 101 and second protocol 103, and the second processing unit 104 may communicate in a second 103, third 108 and fourth 106 protocol. Alternatively, any of the second 103, third 108, and fourth 106 protocols may be the same protocol.

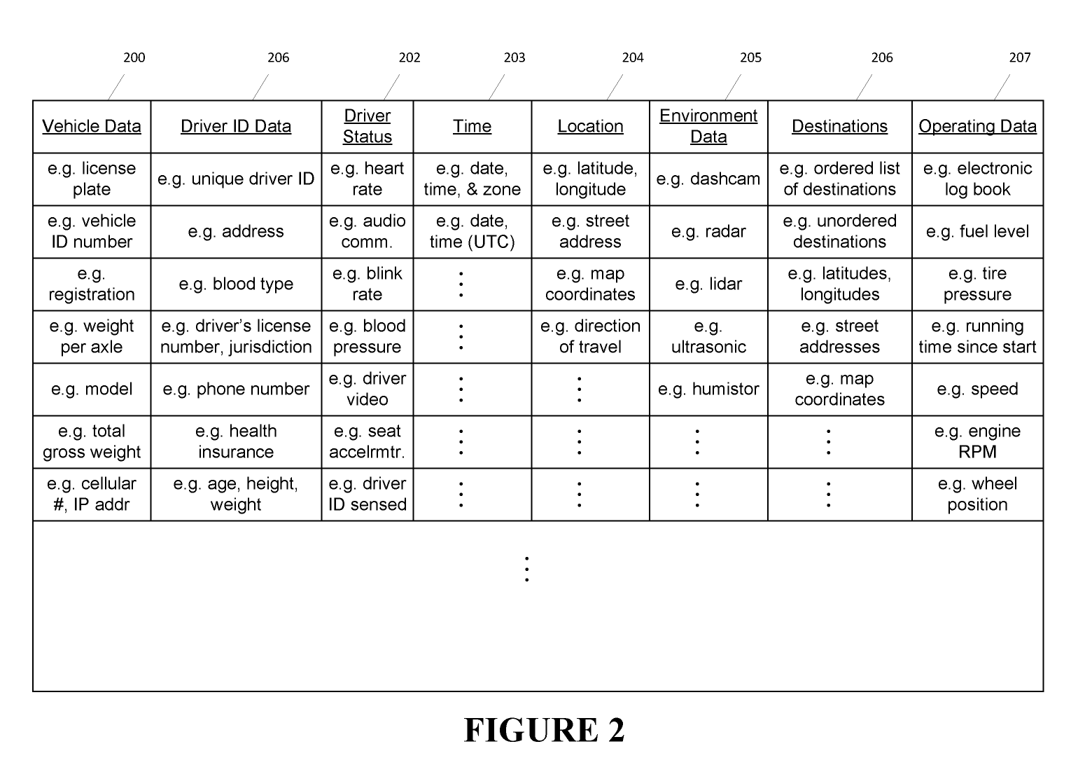

In the embodiment of FIG. 2, the remote server may store a database configured to host the captured data. The database may store vehicle data 200, driver ID data 201, driver status 202, time 203, location 204, environment data 205, destinations 206, and operating data 207. For example, vehicle data 200 may comprise license plate info (e.g. number and jurisdiction), vehicle ID number, registration info (e.g. number and jurisdiction), weight info (e.g. weight per axle, number and configuration of axles, allowance per jurisdiction, total weight), model (e.g. make, name, number), truck cellular number, truck IP address, and other information associated with the vehicle. In another example, driver ID data 201 may comprise a unique driver ID, address, blood type, license info (e.g. number and jurisdiction), phone number, health insurance info, age, height, weight, and other information associated with each unique driver of the vehicle. Driver status 202 may comprise collected data and interpretations of the collected data. For example, driver status may comprise electrocardiographic measurements, heart beat, and an interpretation that the driver may have been drowsy at a time in the video; video of the driver and an interpretation that the driver was inattentive at a time in the video; video of the driver's eyes, calculated blink duration, and the interpretation that the driver was sleepy at a time in the video; electrocardiographic, photoplethysmographic, ballistocardiographic measurements, and an interpretation that the driver sustained a blood-pressure dip at a time in the video; seat accelerometer measurements and an interpretation that the driver was agitated at a time or absent from the driver's seat at a time; audio communications with driver; driver ID sensed, and another status data of the driver.

In the embodiment of FIG. 2, time 203 may comprise a date and time (including time zone) that collected data was collected. Time 203 may also comprise a date and time that a destination was reached or was scheduled to be reached. Time 203 may also comprise a data and time of a price received from a supplier; and an expected service, fuel, or part delivery date. Location 204 of the vehicle may comprise a longitude and latitude, a street address, a map coordinate, and a direction of travel. Destinations 206 may comprise multiple destinations of the vehicle (ordered or unordered). For example, each destination may comprise a longitude and latitude, street address, map coordinate, ordering, scheduled or required arrival time, type, and other descriptors.

In the embodiment of FIG. 2, environment data 205 may comprise a camera (e.g. dashcam), radar, lidar, and ultrasound images of the environment surrounding the vehicle; and a moisture detector (e.g. humistor) exposed to the vehicle environment. Operating data 207 may comprise data collected from the vehicle OBD system 100 and may comprise a diversity of vehicle information (e.g. an electronic log book) that may comprise evaporative emissions system (EVAP) pressure, fuel level, tire pressure, running time since start, vehicle speed, engine revolutions per second (RPM), steering wheel position, and other data that may be collected from an OBD system 100.

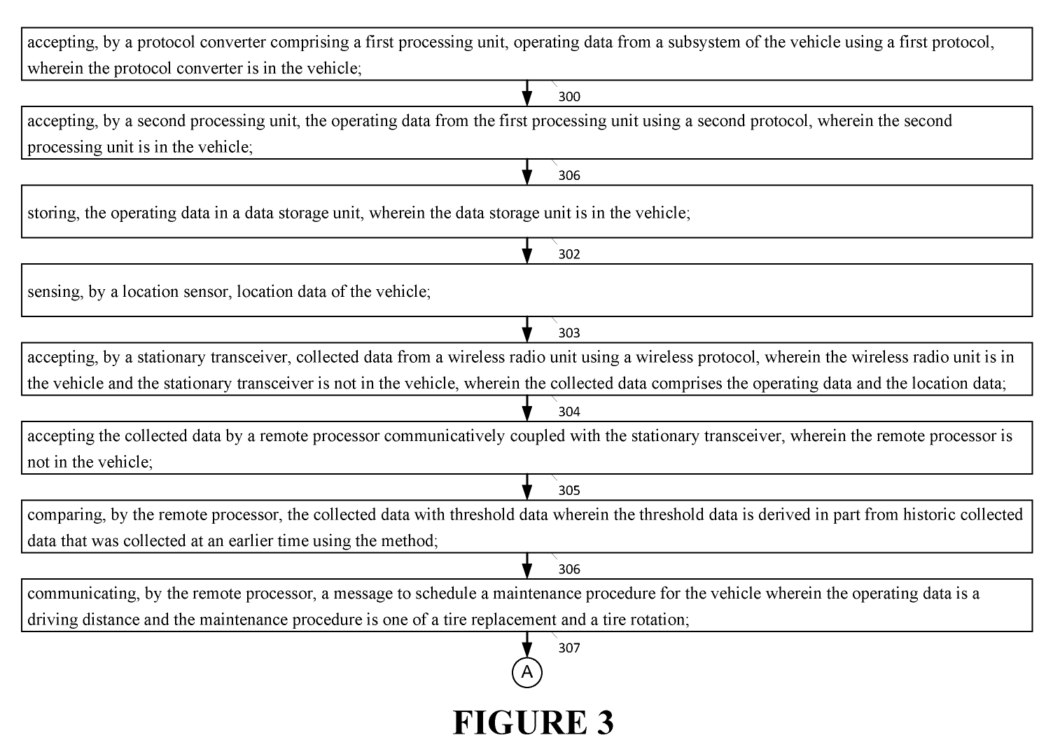

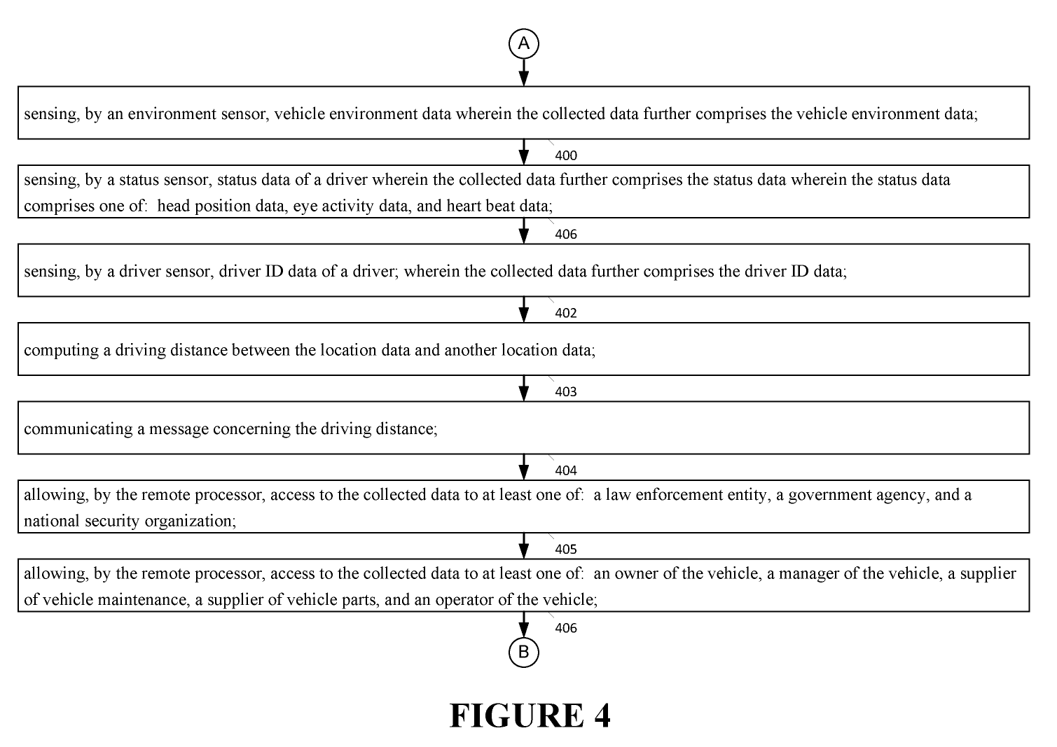

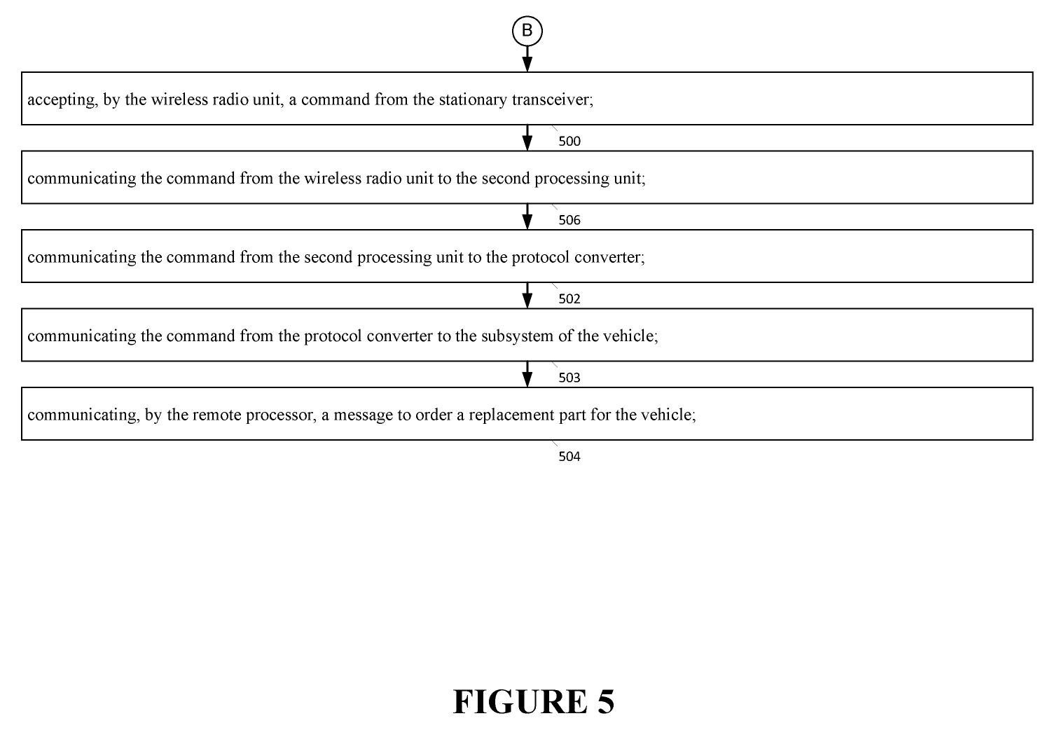

In the embodiment of FIGS. 3-5, a method of remotely monitoring a terrestrial vehicle may comprise: accepting 300, by a protocol converter 102 comprising a first processing unit, operating data 207 from a subsystem 100 of the vehicle using a first protocol 101, wherein the protocol converter 102 is in the vehicle; accepting 301, by a second processing unit 104, the operating data 207 from the first processing unit using a second protocol 103, wherein the second processing unit 104 is in the vehicle; storing 302, the operating data 207 in a data storage unit 109, wherein the data storage unit 109 is in the vehicle; sensing 303, by a location sensor 105, location data 204 of the vehicle; accepting 304, by a stationary transceiver 111, collected data from a wireless radio unit 107 using a wireless protocol 110, wherein the wireless radio unit 107 is in the vehicle and the stationary transceiver 111 is not in the vehicle, wherein the collected data comprises the operating data 207 and the location data 204; accepting 305 the collected data by a remote processor communicatively coupled with the stationary transceiver 111, wherein the remote processor is not in the vehicle; comparing 306, by the remote processor, the collected data with threshold data wherein the threshold data is derived in part from historic collected data that was collected at an earlier time using the method; and communicating 307, by the remote processor, a message to schedule a maintenance procedure for the vehicle wherein the operating data 207 is a driving distance and the maintenance procedure is one of a tire replacement and a tire rotation. The method may further comprise: sensing 400, by an environment sensor 105, vehicle environment data 205 wherein the collected data further comprises the vehicle environment data 205; sensing 401, by a status sensor 105, status data 202 of a driver wherein the collected data further comprises the status data 202 wherein the status data 202 comprises one of: head position data, eye activity data, and heart beat data; sensing 402, by a driver sensor 105, driver ID data 201 of a driver; wherein the collected data further comprises the driver ID data 201; computing 403 a driving distance between the location data 204 and another location data; communicating 404 a message concerning the driving distance; allowing 405, by the remote processor, access to the collected data to at least one of: a law enforcement entity, a government agency, and a national security organization; allowing 406, by the remote processor, access to the collected data to at least one of: an owner of the vehicle, a manager of the vehicle, a supplier of vehicle maintenance, a supplier of vehicle parts, and an operator of the vehicle. The method may further comprise: accepting 500, by the wireless radio unit 107, a command from the stationary transceiver 111; communicating 501 the command from the wireless radio unit 107 to the second processing unit 104; communicating 502 the command from the second processing unit 104 to the protocol converter 102; communicating 503 the command from the protocol converter 102 to the subsystem of the vehicle; communicating 504, by the remote processor, a message to order a replacement part for the vehicle.

1. (canceled)

2. (canceled)

3. (canceled)

4. (canceled)

5. (canceled)

6. (canceled)

7. (canceled)

8. (canceled)

9. A method of remotely monitoring a terrestrial vehicle, the method comprising:
accepting, by a protocol converter comprising a first processing unit, operating data from a subsystem of the vehicle using a first digital protocol, wherein the protocol converter is in or on the vehicle;
accepting, by a second processing unit, the operating data from the first processing unit using a second digital protocol, wherein the second processing unit is in or on the vehicle;
accepting, by a data storage unit, the operating data from the second processing unit
storing, the operating data in the data storage unit using a third digital protocol, wherein the data storage unit is in or on the vehicle;
sensing, by a location sensor, location data of the vehicle;
accepting, by a stationary transceiver, collected data from a wireless radio unit using a wireless protocol, wherein the wireless radio unit is in or on the vehicle and the stationary transceiver is not in and not on the vehicle, wherein the collected data comprises the operating data and the location data;
accepting the collected data by a remote processor communicatively coupled with the stationary transceiver, wherein the remote processor is not in and not on the vehicle; and
allowing access to the collected data to an entity that is at least one of: a government agency, and a national security organization wherein the entity is not primarily a law enforcement entity.

10. The method of claim 9, further comprising sensing, by an environment sensor, vehicle environment data wherein the collected data further comprises the vehicle environment data.

11. The method of claim 9, further comprising sensing, by a status sensor, status data of a driver wherein the collected data further comprises the status data.

12. The method of claim 11, wherein the status data comprises one of: head position data, eye activity data, and heart beat data.

13. The method of claim 9, further comprising sensing, by a driver sensor, driver ID data of a driver, wherein the collected data further comprises the driver ID data.

14. The method of claim 9, further comprising:
computing by the remote processor a driving distance between the location data and one of:
a destination, a service, a fuel, a food, and a room.

15. The method of claim 9, further comprising: requesting by the remote processor pricing for one of: a destination, a service, a fuel, a food, a room, a tire replacement, and a tire rotation.

16. (canceled)

17. The method of claim 9, further comprising allowing, by the remote processor, access to the collected data to at least one of: a supplier of vehicle maintenance, and a supplier of vehicle parts.

18. The method of claim 9, further comprising:
accepting, by the wireless radio unit, a command from the stationary transceiver;
communicating the command from the wireless radio unit to the second processing unit;
communicating the command from the second processing unit to the protocol converter; and
communicating the command from the protocol converter to the subsystem of the vehicle wherein the command is to at least one of: slow, stop, turn off, and lock the vehicle.

19. The method of claim 9, further comprising communicating, by the remote processor, a message to order a replacement part for the vehicle.

20. The method of claim 9, further comprising: comparing, by the remote processor, the collected data with threshold data that is derived in part from historic collected data that was collected at an earlier time using the method.

21. One or more non-transitory processor-readable storage mediums with one or more executable programs stored thereon, wherein the executable programs instruct a plurality of processing units to perform the steps of:
accepting, by a protocol converter comprising a first processing unit, operating data from a subsystem of a vehicle using a first protocol, wherein the protocol converter is in or on the vehicle;
accepting, by a second processing unit, the operating data from the first processing unit using a second protocol, wherein the second processing unit is in or on the vehicle;
accepting, by a data storage unit, the operating data from the second processing unit
storing, the operating data in the data storage unit using a third digital protocol, wherein the data storage unit is in or on the vehicle;
sensing, by a location sensor, location data of the vehicle;
accepting, by a stationary transceiver, collected data from a wireless radio unit using a wireless protocol, wherein the wireless radio unit is in or on the vehicle and the stationary transceiver is not in and not on the vehicle, wherein the collected data comprises the operating data and the location data;
accepting the collected data by a remote processor communicatively coupled with the stationary transceiver, wherein the remote processor is not in and not on the vehicle; and
allowing access to the collected data to an entity that is at least one of: a government agency, and a national security organization wherein the entity is not primarily a law enforcement entity.

22. The method of claim 25, further comprising:
computing a driving distance between the location data and the one of: a destination, a service, a fuel, a food, and a room.

23. The method of claim 25, further comprising:
requesting by the remote processor pricing for one of: a destination, a service, a fuel, a food, a room, a tire replacement, and a tire rotation.

24. The method of claim 25, further comprising:
allowing, by the remote processor, access to the collected data to at least one of: a supplier of vehicle maintenance, and a supplier of vehicle parts.

25. A method of remotely monitoring a terrestrial vehicle, the method comprising:
accepting, by a protocol converter comprising a first processing unit, operating data from a subsystem of the vehicle using a first digital protocol, wherein the protocol converter is in or on the vehicle;
accepting, by a second processing unit, the operating data from the first processing unit using a second digital protocol, wherein the second processing unit is in or on the vehicle;
accepting, by a data storage unit, the operating data from the second processing unit
storing, the operating data in the data storage unit using a third digital protocol, wherein the data storage unit is in or on the vehicle;
sensing, by a location sensor, location data of the vehicle;
accepting, by the a wireless radio unit, a command from the a stationary transceiver;
communicating the command from the wireless radio unit to the second processing unit;
communicating the command from the second processing unit to the protocol converter; and
communicating the command from the protocol converter to the subsystem of the vehicle wherein the command is to at least one of: slow, stop, turn off, and lock the vehicle and wherein the wireless radio unit is in or on the vehicle and the stationary transceiver is not in and not on the vehicle.

26. The method of claim 25, the steps further comprising:
communicating, by the remote processor, a message to order a replacement part for the vehicle.

27. The method of claim 25, further comprising:
comparing, by the remote processor, the collected data with threshold data that is derived in part from historic collected data that was collected at an earlier time using the steps.

28. The method of claim 25, the steps further comprising:
sensing, by a status sensor, status data of a driver wherein the collected data further comprises the status data.

29. The method of claim 25, further comprising:
sensing, by a driver sensor, driver ID data of a driver, wherein the collected data further comprises the driver ID data.
